(19) United States
(12) Patent Application Publication
(10) Pub. No.: US 2016/0330919 A1
(43) Pub. Date: Nov. 17, 2016

(54) Plant Growing System

(71) Applicant: Garth L. Choate, Bald Knob, AR (US)

(72) Inventor: Garth L. Choate, Bald Knob, AR (US)

(21) Appl. No.: 14/710,235

(22) Filed: May 12, 2015

(51) Int. Cl. A01G 27/04; A01G 1/00; A01G 9/02

(52) U.S. Cl. CPC A01G 27/04; A01G 9/02; A01G 1/001

(57) ABSTRACT

A method, a system and a converter plate for use in a system for growing plants comprising a converter plate having a generally flat circular portion having a central portion having a first thickness and an outer circular portion that is thinner than the first thickness and a plurality of hollow wicking cup legs extending from the central portion and the hollow wicking cup legs having open tops where the hollow wicking cup legs join the central portion. At least one of the hollow wicking cup legs having a base portion having an opening therein to promote the wicking of water through capillary action when the converter plate is in use. Surrounding the central portion is an outer ring that is of thinner thickness than the central portion. The outer ring includes cutting guides to facilitate the cutting of the outer ring to reduce the diameter of the converter plate.

### FIELD OF THE INVENTION

The present invention relates as indicated to a plant growing system, and relates more particularly to an insert for use with a container for transferring water to the growing media in a plant pot by capillary action.

### BACKGROUND OF THE INVENTION

Growing containers have been in use for a very many years. With all of the containers available there have been countless types converted to plant growing containers. With the world wide use of the plastic 5 gallon buckets, it was inevitable that they would also be used as plant growing containers.

Using a container such as a five gallon bucket allows you to grow more and better than in a conventional garden measured by the plant or by the square foot of space used. In a conventional garden it is difficult to create growing soil with the optimum pH level and the perfect amount of nitrogen, phosphate and potash. However, when mixing three and half gallons of soil for a grow bucket you can get the correct mix the first time every time. Even if you could accomplish the correct soil conditions in a garden, it will also be the perfect environment for growing weeds and grass between the plants and in the rows. Using plant growing containers eliminates the headache of weeding as well as providing the perfect growing conditions.

Five gallon bucket gardening solves many of the problems conventional gardeners have to deal with. The biggest problem that it solves is the need for the right soil to create a garden. Instead trying to grow plants in of rocky or clay soil, you can mix your own soil you can have a near perfect blend of soil for what you want to grow.

Another problem that growing in a five gallon bucket solves is that you can raise the buckets up as high as needed. Short saw horses and 2×4s makes a great platform. This eliminates bending, stooping and squatting. With a little infrastructure you will never have to bend over or squat down again to garden.

Furthermore, you can create a five gallon garden even if you do not have a garden spot, or if you have a beautiful lawn you do not want to till up or have a concrete or paved over parking area, have a flat roof top, or rent and suspect you will have to move. If you do move, you can take your garden with you dirt and all. The grower can place the buckets on your porch, deck or patio, anywhere you have sunlight. If you have security problems from two or four legged vermin, you can bring your buckets in at night and lock them up. The portability of five gallon bucket gardening is a key factor.

In order to effectively use a five gallon bucket as a plant growing container, it has been found that a grow bucket converter plate is needed as will be described below with respect to the drawings and the detailed description of the invention.

### OBJECTS AND SUMMARY OF THE INVENTION

An object of the invention is to provide a grow bucket converter plate for using a five gallon bucket to grow plants.

Another object of the invention is to provide a grow bucket converter plate having a flexible skirt for contacting the interior wall of the bucket to prevent soil from falling into the bottom of the bucket below the converter plate.

Still another object of the invention is to provide a converter plate having supporting legs to provide water storage space at the bottom of the bucket.

Yet another object of the invention is to provide openings in the supporting legs to facilitate the flow of water from the storage space into the soil through capillary action.

Still another object of the invention is to provide openings in the converter plate to permit water to flow from the soil into the water storage space.

Yet another object of the invention is to provide cutting rings in the skirt to facilitate reducing the diameter of the converter plate.

It must be understood that no one embodiment of the present invention need include all of the aforementioned objects of the present invention. Rather, a given embodiment may include one or none of the aforementioned objects. Accordingly, these objects are not to be used to limit the scope of the claims of the present invention. Other objects, uses and advantages will be apparent from a reading of this description which proceeds with reference to the accompanying drawings forming a part thereof.

In summary, the invention is directed to a method, a system and a converter plate for use in a system for growing plants comprising a converter plate having a generally flat circular portion having a central portion having a first thickness and an outer circular portion having a thickness that is thinner than the first thickness and a plurality of hollow wicking cup legs extending from the central portion and the hollow wicking cup legs having open tops where the hollow wicking cup legs join the central portion and at least one of the hollow wicking cup legs having a base portion having an opening therein to promote the wicking of water through capillary action when the converter plate is in use. Surrounding the central portion is an outer ring that is of thinner thickness than the central portion. The outer ring includes cutting guides to facilitate the cutting of the outer ring to reduce the diameter of the converter plate to allow the converter plate to be adjusted to fit buckets of different diameters.

### BRIEF DESCRIPTION OF THE DRAWINGS

FIG. 1 is an top plan view of plant growing container with portions broken away to reveal the converter plate;

FIG. 2 is a top isometric view of the converter plate;

FIG. 3 is a bottom isometric view of the converter plate of FIG. 2; and,

FIG. 4 is cross-sectional view of the plant growing container in use.

### DESCRIPTION OF THE PREFERRED EMBODIMENT

This invention will now be described by way of example only with reference to the accompanying drawings. It should be appreciated however that modifications and improvements may be made to the invention without departing from the spirit thereof.

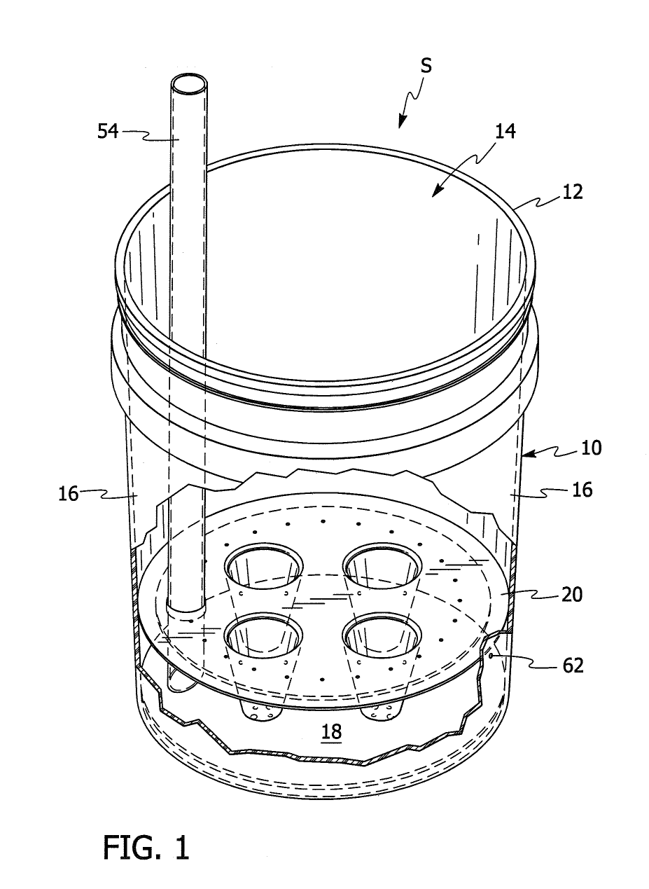

FIG. 1 shows the plant growing system S having a bucket 10 having an upper edge 12 defining an open top 14. A sidewall 16 extends downwardly from the upper edge 12 to the bottom 18. Preferably, the bucket 10 is of the common five gallon variety which have become ubiquitous and are therefore easily acquired and relatively inexpensive. Usually and preferably the five gallon buckets are constructed of plastic. A white food grade plastic bucket 10 is desired to prevent unwanted contamination of the soil and plants. Furthermore, it has been found that light colored buckets 10 do not absorb as much heat from sunlight which can overheat the growing plants. Therefore buckets of white, cream or light grey are preferred over black or other dark colors.

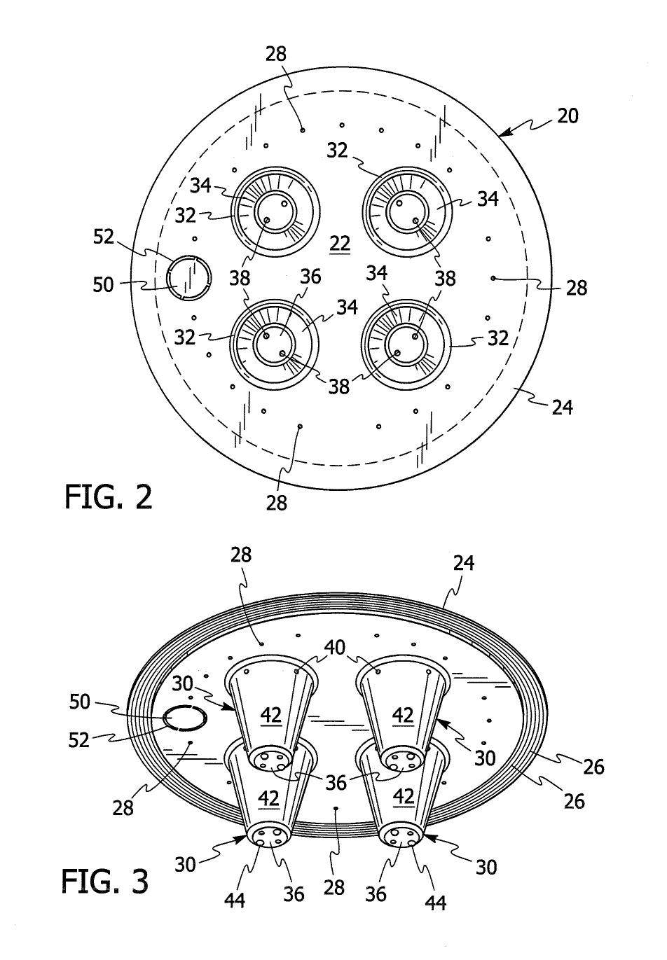

The converter plate 20 sets on the generally flat bottom 18 of the bucket 10 as shown in FIG. 1. In FIGS. 2 and 3, the converter plate 20 is shown in detail. The converter plate 20 is preferably formed of plastic and includes a generally central flat portion 22 preferably of about ⅛ of an inch in thickness. Surrounding the central flat portion 22 is an outer ring 24 which is preferably thinner than the central flat portion and preferably includes a plurality of cutting guides 26. Since the five gallon buckets are not always uniform in shape and diameter, it may be necessary to adjust the diameter of the converter plate 20. The use of thinner plastic in the outer ring 24 and cutting guides 26 facilitates adjustment of the converter plate 20 to fit smaller diameter buckets 10. The central flat portion 22 preferably includes a plurality of drain holes 28 which allow excess water to drain through the converter plate 20. The drain holes 28 are preferably small so as to prevent soil from falling through the central flat portion 22 to the bottom 18 of the bucket 10.

Depending downwardly from the central flat portion 22 are hollow wicking cup legs 30. Four hollow wicking cup legs 30 as shown are preferred to provide adequate stability and wicking, although more or less could be used without departing from the scope of the invention. Each of the hollow wicking cup legs 30 joins the central flat portion 22 at their periphery 32 to form an open topped cup 34. The cups 34 are preferably angled in a cone shape to a smaller generally flat bottom 36. Having angled sides on the cups 34 facilitates the easy removal of soil from the cup 34. Each bottom 36 includes at least one opening 38 to allow water to pass from the bucket 10 into the cup 34. Preferably, a nub or protuberance 40 is located on the outer wall 42 of the hollow wicking cup legs 30 to space the opening 38 from the bottom 18 of the bucket to prevent the opening 38 from get blocked.

Preferably each of the hollow wicking cup legs includes a protuberance or nub 44 on the outer wall 46. This nub 44 facilitates separation of the converter plates when they are stacked together for shipment or storage.

The central flat portion 22 also preferably includes a knockout 50 that is formed by a weakened circle 52 in the plastic of the central flat portion 22. When it is desired to use a water fill tube 54, the knockout is removed and the fill tube 54 can be inserted through the central flat portion 22 so that water can be added to the bucket 10 through the fill tube 54.

To use the plant growing system S, it may be necessary to fit the converter plate 20 to your bucket 10. There is no standardization on the diameters of five gallon buckets. Therefore no two bucket manufacturers use the same dimensions when designing their buckets. The outer ring 24 will usually fit the larger five gallon buckets. The thicker central flat portion 22 is generally the size of the smallest five gallon bucket 10. A pair of heavy duty scissors works well to trim the outer ring 24 all the way around along the cutting guides 26 until the converter plate 20 drops down until the four hollow wicking cup legs 30 touch the bottom 18 of the bucket 10. It is important to get a good fit between the sidewall 16 and the converter plate 20 to keep soil out of the water reservoir 60 which is the 10 area between the central flat portion 22 of the converter plate 20 and the bottom 18 of the bucket 10.

Before installation of the converter plate 20 into the bucket 10, it is preferable that a plurality of water overflow holes 62 be formed in the sidewall 16 of the bucket. These overflow holes 62 prevent drowning or waterlogging the plant. To mark the height location of the overflow holes, the bucket 10 is placed on a flat surface and the converter plate 20 is placed beside the bucket 10 and the bucket 10 is marked where the outer ring 24 of the converter plate 20 touches the sidewall 16 of the bucket 10. Overflow holes 62 are then drilled along the marks. The horizontal overflow hole 62 spacing location around the bucket 10 is not critical. The bottom of the bucket 10 is usually about ⅜″ thick. When the converter plate 20 is installed in the bucket 10, the overflow holes 62 will be just under the central flat portion 22 of the converter plate 20. This way the bucket will not leak soil, but will leak excess water out.

Before the converter plate 20 is installed, the four wicking cup legs 30 should be filled with damp soil. When the hollow wicking cup legs 30 are full of lightly compressed damp soil, they will transfer water from the water reservoir 60 up into the growing soil. There is no need to compact/pound the soil in with a punch and hammer, nor will loosely dumped in soil transfer water well enough. The soil should just be pressed in with fingertips.

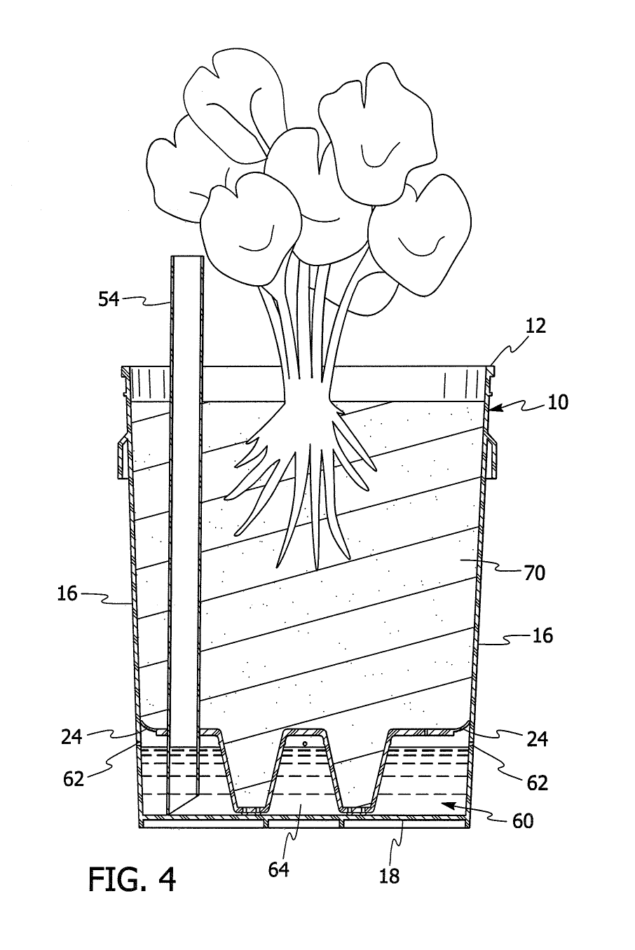

FIG. 4 shows the interior of the bucket 10 with the converter plate 20 installed. Water 64 sets at the bottom 18 of the bucket 10. Soil 70 is located in the hollow wicking cup legs 30 and above the central flat portion 22. Outer rings 24 prevent the soil 70 from entering the water reservoir 60. Water can be added to the water reservoir 60 via fill tube 54. If water is added directly to the soil 70 or it rains, excess water will drain through the soil and through the drain holes 28 into the water reservoir 60. Excess water in the reservoir 60 will then drain out through overflow holes 62.

The converter plate 20 is can be injection molded and is preferably formed of polyethylene, although other plastics or materials and methods of construction can be used.

While this invention has been described as having a preferred design, it is understood that it is capable of further modifications, uses and/or adaptions of the invention following in general the principle of the invention and including such departures from the present disclosure as come within the known or customary practice in the art to which the invention pertains and as maybe applied to the central features hereinbefore set forth, and fall within the scope of the invention and the limits of the appended claims.

I claim:

1. A converter plate for use in a system for growing plants, comprising:
a) said converter plate having a generally flat circular portion;
b) said flat circular portion having a central portion having a first thickness and an outer circular portion having a thickness that is thinner than said first thickness;
c) a plurality of hollow wicking cup legs extending from said central portion;
d) said plurality of hollow wicking cup legs having open tops where said hollow wicking cup legs join said central portion;
e) at least one of said hollow wicking cup legs having a base portion having an opening therein to promote the wicking of water through capillary action when said converter plate is in use.

2. The converter plate for use in a system for growing plants as set forth in claim 1 wherein;
a) said outer circular portion having a plurality of cutting guides to facilitate evenly reducing the diameter of said converter plate by cutting.

3. The converter plate for use in a system for growing plants as set forth in claim 1 wherein;
a) each of said plurality of hollow wicking cups having an outer wall having at least one protuberance thereon for facilitating separation of a plurality of stacked converter plates.

4. The converter plate for use in a system for growing plants as set forth in claim 1 wherein;
a) each of said plurality of hollow wicking cups having an outer wall having at least one protuberance thereon extending from said base portion adjacent said opening.

5. The converter plate for use in a system for growing plants as set forth in claim 1 wherein;
a) said central portion has a plurality of small drain holes formed therein.

6. The converter plate for use in a system for growing plants as set forth in claim 1 wherein;
a) said central portion includes a knock-out section that can be removed so that a water fill tube can be placed in an opening that is created when the knock-out section is removed.

7. A system for growing plants in a container, comprising:
a) an open topped bucket having closed bottom and a substantially vertically extending sidewall;
b) said sidewall having at least one opening therein;
c) a converter plate sized to fit within the bucket and continuously engage the sidewall;
d) said converter plate having a generally flat circular portion;
e) said flat circular portion having a central portion having a first thickness and an outer circular portion having a thickness that is thinner than said first thickness;
f) a plurality of hollow wicking cup legs extending from said central portion;
g) said plurality of hollow wicking cup legs having open tops where said hollow wicking cup legs join said central portion;
h) at least one of said hollow wicking cup legs having a base portion that rests on said bucket bottom and said base portion having an opening therein to promote the wicking of water through capillary action when said converter plate is in use;

8. The system for growing plants in a container as set forth in claim 7, wherein;
a) said outer circular portion having a plurality of cutting guides to facilitate evenly reducing the diameter of said converter plate by cutting so that said converter plate can be sized to fit within the bucket.

9. The system for growing plants in a container as set forth in claim 7, wherein;
a) each of said plurality of hollow wicking cups having an outer wall having at least one protuberance thereon extending from said base portion adjacent said opening.

10. The system for growing plants in a container as set forth in claim 7, wherein;
a) said central portion has a plurality of small drain holes formed therein.

11. The system for growing plants in a container as set forth in claim 7, wherein;
a) said central portion includes a knock-out section that can be removed so that a water fill tube can be placed in an opening that is created when the knock-out section is removed.

12. The system for growing plants in a container as set forth in claim 7, wherein;
a) said at least one opening in said sidewall is located above the bucket bottom and below the flat circular portion of the converter plate.

13. A method of growing plants in a container having a closed bottom, a cylindrical side wall and an open top, comprising the steps of:
a) placing a converter plate in a container wherein the converter plate has generally flat circular portion and said generally flat circular portion having a central portion having a first thickness and an outer circular portion having a thickness that is thinner than said first thickness and a plurality of hollow wicking cup legs extending from said central portion and said plurality of hollow wicking cup legs having open tops where said hollow wicking cup legs join said central portion and at least one of said hollow wicking cup legs having a base portion having an opening therein to promote the wicking of water through capillary action when said converter plate is in use;
b) wherein placing the converter plate in the container includes setting the converter plate at the bottom of the container and engaging an outer extremity of the outer circular portion with the sidewall of the container;
c) placing an opening of a size large enough to allow water to pass therethrough in the sidewall above the bottom of the container and below the flat circular portion of the converter plate;
d) placing a predetermined amount of soil in the container on top of the converter plate and pressing a part of the soil into the hollow wicking cup legs.

14. The method of claim 13 further comprising the step of:
a) adjusting the diameter of the converter plate by cutting along cutting guides in the outer circular portion.

15. The method of claim 13 further comprising the step of:
a) inserting a water fill tube through the converter plate.
